(19) United States
(12) Patent Application Publication
(10) Pub. No.: US 2026/0228148 A1
(43) Pub. Date: Aug. 6, 2026

(54) ELECTRONIC DEVICE AND METHOD FOR MANAGING RESET SIGNALS

(71) Applicant: Nuvoton Technology Corporation, Hsinchu Science Park (TW)

(72) Inventor: Yung-Chi LAN, Taichung City (TW)

(21) Appl. No.: 19/331,555

(22) Filed: Sep. 17, 2025

(30) Foreign Application Priority Data
Feb. 4, 2025 (TW) 114103926

(51) Int. Cl. G06F 13/362; G06F 9/4401

(52) U.S. Cl. CPC G06F 13/362; G06F 9/4401

(57) ABSTRACT

An electronic device is provided. The electronic device includes a first master device, a slave device, and a bus state monitor. The slave device is connected to the first master device through a bus. The bus state monitor is connected to the bus. The first master device is configured to transmit an address to the slave device to request to read data in the slave device. The bus state monitor is configured to receive the first reset request signal. The first reset request signal indicates that there is a request to reset the slave device. In response to receiving the first reset request signal, the bus state monitor is configured to prevent a reset signal from being transmitted to the slave device, after the slave device has accepted the request and before the first master device acknowledges the reception of the data transmitted from the slave device.

### CROSS REFERENCE TO RELATED APPLICATIONS

This application claims priority of Taiwan patent application No. 114103926, filed Feb. 4, 2025, the entirety of which is incorporated by reference herein.

### TECHNICAL FIELD

The present disclosure relates to the reset of the electronic device, and, in particular, it relates to managing reset signals in the electronic device.

### BACKGROUND

The system on a chip (SoC) system consists of multiple master devices and slave devices. Data transfer between master and slave devices by means of a bus. To satisfy the requirement of more and more complicated function of the SoC, current bus is developed oriented towards high throughput, security, and recognizable device attributes. These require a rigorous handshake mechanism between the master device and the slave device to achieve. However, the handshake mechanism can be done only when both the master device and the slave device are in the active state. If one of the master device or the slave device is reset during the hand shake process, the handshake cannot be completed. One side of the master device or the slave device will keep waiting for the response of the other side and cannot perform the subsequent process. Finally, the system will be idled or crushed.

Some devices are equipped with a watch dog timer (WDT). The WDT keeps counting down, and the master device cyclically reset the WDT. Upon the WDT expires, the WST resets the entire system. If the master device is out-of-function because of some reasons and thus can't reset the WDT, the WDT will reset the system. However, WDT must wait until the timer expires to reset the entire system. Furthermore, the master device and the slave device can't continue with what they were doing before the reset, after the system is reset. The master device and the slave device need a cycle of time to restore to the state which they were in before being reset. This is dangerous for application scenario with stringent latency requirements (such as the autopilot).

Thus, a mechanism for managing the reset signal or the reset timing in the system is required to solve the aforementioned problem.

### BRIEF SUMMARY

Embodiments of the present disclosure provide an electronic device, comprising: a first master device, a slave device, and a bus state monitor. The slave device is connected to the first master device through a bus. The bus state monitor is connected to the bus. The first master device is configured to transmit an address to the slave device to request to read data in the slave device. The bus state monitor is configured to receive the first reset request signal. The first reset request signal indicates that there is a request to reset the slave device. In response to receiving the first reset request signal, the bus state monitor is configured to prevent a reset signal from being transmitted to the slave device, after the slave device has accepted the request and before the first master device acknowledges the reception of the data transmitted from the slave device.

Embodiments of the present disclosure provide a method for managing reset signals, applied in an electronic device. The electronic device comprises a first master device, a slave device, and a bus state monitor. The slave device connects to the first master device through a bus, and the bus state monitor connects to the bus. The method comprises an operation in which the first master device transmits an address to the slave device through the bus to request to read data in the slave device. The method further comprises an operation in which the bus state monitor receives a first reset request signal. The first reset request signal indicates that there is a request to reset the slave device. The method further comprises an operation in which the bus state monitor prevents a reset signal from being transmitted to the slave device, after the slave device has accepted the request and before the first master device acknowledges the reception of the data transmitted from the slave device, in response to receiving the first reset request signal.

### BRIEF DESCRIPTION OF THE DRAWINGS

The present disclosure can be more fully understood by reading the subsequent detailed description and examples with references made to the accompanying drawings, wherein:

FIG. 1 is a block diagram of the electronic device in accordance with the embodiments of the present disclosure;

FIG. 2 is an illustration diagram showing the operation process in accordance with the embodiments of the present disclosure;

FIGS. 3A, 3B are block diagrams of the electronic device 20 in accordance with the embodiments of the present disclosure;

FIG. 4 is an illustration diagram showing the operation process in accordance with the embodiments of the present disclosure;

FIG. 5 is an illustration diagram showing the operation process in accordance with the embodiments of the present disclosure; and

FIG. 6 is a flow diagram of the method for managing the reset signal in accordance with the embodiments of the present disclosure.

### DETAILED DESCRIPTION

The following description is made for the purpose of illustrating the general principles of the disclosure and should not be taken in a limiting sense. The scope of the disclosure is best determined by reference to the appended claims.

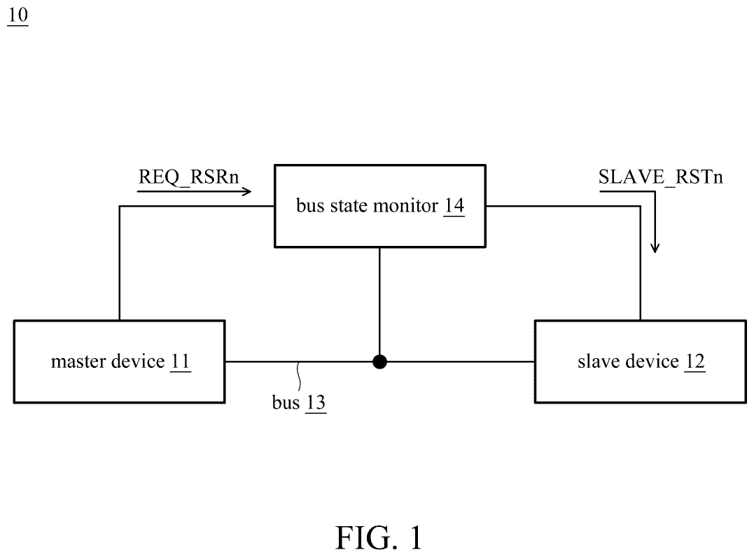

Refer to FIG. 1, FIG. 1 is a block diagram of the electronic device 10 in accordance with the embodiments of the present disclosure. For example, the electronic device 10 is a SoC system or a micro-processing system. For example, the electronic device 10 can be implemented in a computer, a mobile device, a smart phone, a wearable device, or an Internet-of-things device. The electronic device 10 comprises a master device 11, a slave device 12, a bus 13, and a bus state monitor 14. The slave device 12 connects to the master device 11 through the bus 13. The bus state monitor 14 connects to the bus 13. For example, the master device 11 may be, but not limited to, a central processing unit (CPU), a peripheral direct memory access (PDMA), a micro-processor, or other devices. For example, the slave device 12 may be, but not limited to, different types of memories, such as dynamic random-access memory (DRAM), statistic random-access memory (SRAM), read-only memory, or flash memory, or other peripheral devices. The slave device 12 may also be a device capable to be read and reset by the master device 11.

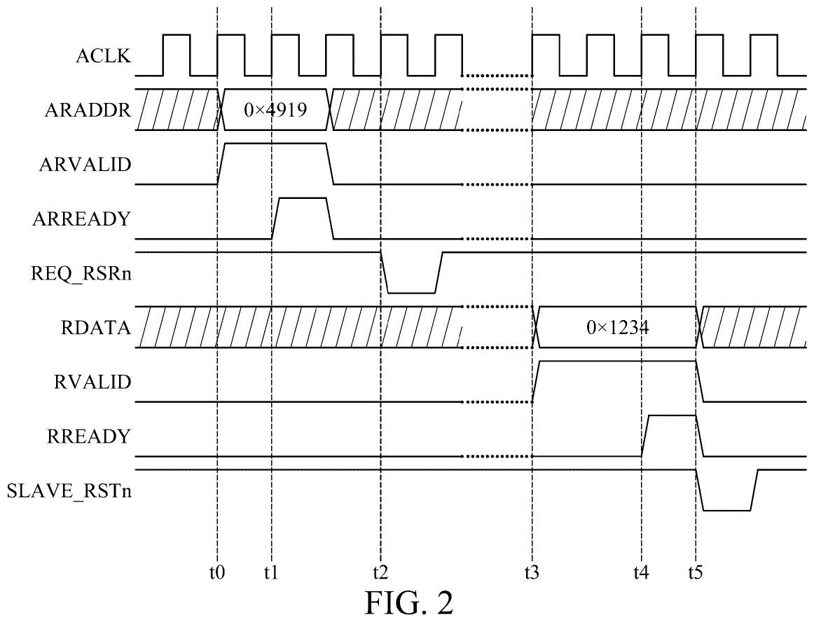

The master device 11 is configured to transmit an address to the slave device 12 through the bus 13. The bus state monitor 14 is configured to receive the reset request signal REQ_RSRn from the master device 11. The reset request signal REQ_RSRn indicates that there is a request to reset the slave device 12. The bus state monitor 14 is further configured to monitor the signals on the bus 13 and determine to prevent or allow the reset signal SLAVE_RSTn to be transmitted to the slave device 12. The reset signal SLAVE_RSTn is used to control the slave device 12 to reset. The operation process of the electronic device 10 is described below referring to FIG. 2.

Refer to FIG. 2, FIG. 2 is an illustration diagram showing the operation process in accordance with the embodiments of the present disclosure. The operation process shown in FIG. 2 can be implemented in the electronic device 10. In some embodiments, the master device 11 and the slave device 12 apply advanced extensible interface(AXI) protocol to communicate with each other on the bus 13. The bus 13 may comprise six lines respectively configured to transmit the ARADDR signal, ARVALID signal, ARREADY signal, RDATA signal, RVALID signal, and RREADY signal. ARADDR signal is transmitted from the master device 11 to the slave device 12 and is configured to indicate that the master device 11 is requesting to read an address of data in the slave device 12. ARVALID signal is transmitted from the master device 11 to the slave device 12. When the ARVALID signal is transmitted or set to a certain level (e.g. high level), the ARVALID signal indicates that the signal currently being transmitted on the line configured to transmit the ARADDR signal is a valid read address or control message. ARREADY signal is transmitted from the slave device 12 to the master device 11. When the ARREADY signal is transmitted or set to a certain level (e.g. high level), the ARREADY signal indicates that the slave device 12 has accepted the read request. For example, the slave device 12 may determine to transmit the ARREADY signal or to set the ARREADY to high level, when the ARVALID signal is set to high level and the slave device 12 can reply the data requested by the master device 11. RDATA signal is transmitted form the slave device 12 to the master device 11 and is configured to indicate the data transmitted from the slave device 12 to the master device 11 (such as the data requested by the master device 11 using the ARADDR signal). RVALID signal is transmitted from the slave device 12 to the master device 11. When the RVALID signal is set to a certain level (e.g. high level), the RVALID signal indicates that the signal currently being transmitted on the line configured to transmit the RDATA signal is valid data. RREADY signal is transmitted from the master device 11 to the slave device 12. When the RREADY signal is transmitted or set to a certain level (e.g. high level), the RREADY signal indicates that the master device 11 can receive data or that the master device 11 has already received the data indicated by the RDATA signal. Furthermore, ACLK signal is clock signal. For example, ACLK signal is generated by a clock generator and transmitted to the master device 11 and the slave device 12.

At time point t0, the master device 11 requests to read data whose address is 0x4919 in the slave device 12. The master device 11 transmits the ARADDR signal, and the ARADDR signal indicates the address of the data requested to read. The master device 11 further set the ARAVALID signal to the high level. At time point t1, the slave device 12 sets the ARREADY signal to high level to indicate that the slave device 12 has accepted the request from the master device 11 to read data at address 0x4919. At time point t2, the bus state monitor 14 receives the reset request signal REQ_RSRn from the master device 11 (or other components in the electronic device 10). For example, the master device 11 may keep transmitting the reset request signal REQ_RSRn which is set to a low level or a high level for a cycle of the clock signal. The reset request signal REQ_RSRn indicates that there is a request to reset the slave device 12 (i.e. the slave device 12 is requested to be reset). The bus state monitor 14 determines whether this request is allowed based on the signals on the bus 13. Because, at time point t2, the ARREADY signal was once set to a high level (which means that the slave device 12 has accepted the read request), and the RREADY signal hasn't been set to the high level (which means that the master device 11 hasn't acknowledged the reception of the data transmitted from the slave device 12). The bus state monitor 14 determines that the whole transmission procedure isn't complete and thus prevents the reset signal SLAVE_RSTn from being transmitted to the slave device 12. Specifically, the bus state monitor 14 doesn't transmit the reset signal SLAVE_RSTn to the slave device 12.

At time point t3, the slave device 12 transmits high level RVALID signal and transmits the RDATA signal to the master device 11. The RDATA signal indicates the data at 0x4919. At time point t4, the master device 11 receives data indicated by the RDATA signal and thus transmits high level RREADY signal to indicate that the master device 11 has received the data. For example, the master device 11 may keep transmitting high level RREADY signal for a cycle of the clock signal. At time point t5, the bus state monitor 14 detects that the RREADY signal is set to a high level and transmits the reset signal SLAVE_RSTn to the slave device 12. The slave device 12 resets itself after receiving the reset signal SLAVE_RSTn.

Thus, the bus state monitor 14 is configured to prevent the reset signal SLAVE_RSTn from being transmitted to the slave device 12, after the slave device 12 has accepted the read request and before the master device 11 acknowledges the reception of the data transmitted from the slave device 12. The bus state monitor 14 is further configured to allow the reset signal SLAVE_RSTn to be transmitted to the slave device 12, after the acknowledges the reception of the data transmitted from the slave device 12. In some embodiments, the bus state monitor 14 prevents the reset signal SLAVE_RSTn from being transmitted to the slave device 12, after the slave device 12 transmits the ARREADY signal (e.g. the slave device 12 sets the ARREADY signal on the bus 13 to a high level) and before the master device 11 transmits the RREADY signal (e.g. the master device 11 sets the RREADY signal on the bus 13 to a high level). It should be noted that once the ARREADY signal has been set to a high level (and does not need to stay at the high level), the bus state monitor 14 determines that the slave device 12 has accepted the read request. Furthermore, the bus state monitor 14 is further configured to allow the reset signal SLAVE_RSTn to be transmitted to the slave device 12, after the master device 11 transmits the RREADY signal (e.g. the master device 11 sets the RREADY signal on the bus 13 to a high level).

If the bus state monitor 14 doesn't prevent the reset signal SLAVE_RSTn from being transmitted to the slave device 12 at time point t2, the slave device 12 will be reset and won't transmit the data requested by the master device 11. The master device 11 will not be able to perform the subsequent processing because it does not obtain the required data. This will cause the entire system crashed. Embodiments of the present disclosure can solve this problem. Furthermore, comparing to deal the reset issue using the WDT, using the bus state monitor 14 can execute the reset instruction more promptly (without waiting for the expiration of the WDT). Furthermore, the embodiments of the present disclosure do not need to reset the whole system.

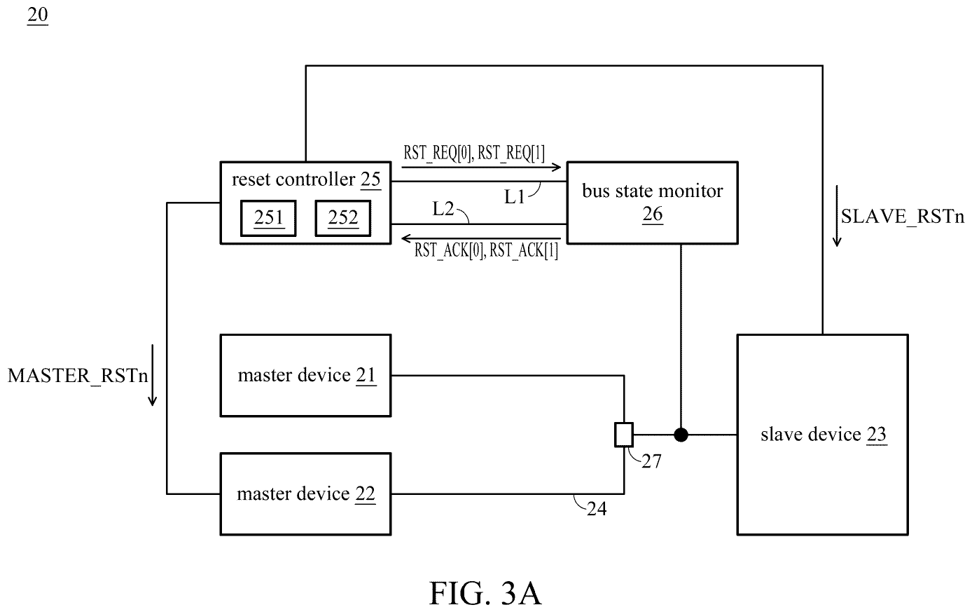

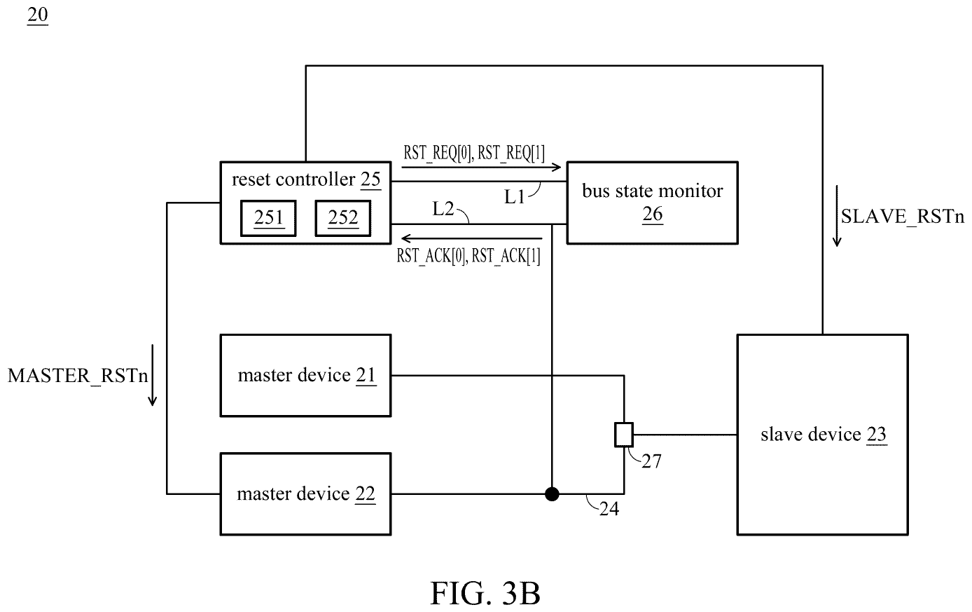

Refer to FIGS. 3A and 3B, FIGS. 3A and 3B are block diagrams of the electronic device 20 in accordance with the embodiments of the present disclosure. The electronic device 20 is similar to the electronic device 10. The electronic device 20 comprises the master device 21, the master device 22, the slave device 23, the bus 24, the reset controller 25, and the bus state monitor 26. The master device 21 and the master device 22 connect to the slave device 23 through the bus 24. The reset controller 25 connects to the master device 21, the master device 22, the slave device 23, and the bus state monitor 26. The electronic device 10 is similar to the electronic device 20. The master device 21 and the master device 22 are similar to the master device 11. The slave device 23 is similar to the slave device 12, the bus 24 is similar to the bus 13, and the bus state monitor 26 is similar to the bus state monitor 14. In some embodiments, the master device 21 can reset the master device 22 and the slave device 23 via the reset controller 25. The master device 22 can reset the slave device 23. For example, the master device 21 may be the CPU, and the master device 22 may be the PDMA.

Furthermore, the electronic device 20 further comprises the bus connection point 27. The bus connection point 27 is on the bus 24. The bus connection point 27 is configured to determine to transmit either the signal from the master device 21 or the signal from the master device 22 to the slave device 23. For example, the bus connector 27 is a switch or a multiplexer. For example, the bus connection point 27 may comprise the first end connected to the master device 21, the second end connected to the master device 22, and the third end connected to the slave device 23. In the embodiment shown in FIG. 3A, the bus state monitor 26 is connected between the bus connection point 27 and the slave device 23. In the embodiment shown in FIG. 3B, the bus state monitor 26 is connected between the bus connection point 27, the master device 21, and the master device 22. In some embodiments, the bus 24 may consist of multiple flip-flops. Thus, the signal transmission speed on the bus 24 is slow. The connection point of the bus state monitor 26 and the bus 24 being close to the master device 21 and the master device 22 is advantageous to receive the signals of the master device 21 and the master device 22 earlier. On the other hand, the connection point of the bus state monitor 26 and the bus 24 being close to the slave device 23 is advantageous to receive the signals of the slave device 23 earlier.

In some embodiments, the lines L1 and L2 connect between the reset controller 25 and the bus state monitor 26. Line L1 is configured to transmit reset request signals RST_REQ[0], RST_REQ[1], and line L2 is configured to transmit reset acknowledge signals RST_ACK[0], RST_ACK[1]. The reset request signals RST_REQ[0], RST_REQ[1] are transmitted from the reset controller 25 to the bus state monitor 26. The reset request signal RST_REQ[0] corresponds to the slave device 23, and the reset request signal RST_REQ[1] corresponds to the master device 22. The reset controller 25 is configured to transmit the reset request signal RST_REQ[0] or the reset request signal RST_REQ[1] which is set to a certain level (e.g. high level) to indicate that there is a request for a reset of the slave device 23 or the master device 22. The reset acknowledge signals RST_ACK[0], RST_ACK[1] are transmitted from the bus state monitor 26 to the reset controller 25. The reset acknowledge signal RST_ACK[0] corresponds to the slave device 23 and the reset request signal RST_REQ[0], and the reset acknowledge signal RST_ACK[1] corresponds to the master device 22 and the reset request signal RST_REQ[1]. The bus state monitor 26 is configured to transmit the reset acknowledge signal RST_ACK[0] or the reset acknowledge signal RST_ACK[1] which is set to a certain level (e.g. high level) to indicate that the reset of the slave device 23 or the master device 22 is acknowledged. In some embodiments, the reset request signals RST_REQ[0] and RST_REQ[1] are different bits of the same signal. The reset acknowledge signals RST_ACK[0] and RST_ACK[1] are different bits of the same signal. In other words, the reset request signals RST_REQ[0], RST_REQ[1] and the reset acknowledge signals RST_ACK[0], RST_ACK[1] are multi-bit signals. Each of the bits corresponds to a resettable component in the electronic device 20. The reset controller 25 is configured to set different bits of the multi-bit signal to “0” or “1” to request to reset the corresponding signal. The bus state monitor 26 is configured to set different bits of the multi-bit signal to “0” or “1” to indicate an acknowledgement to reset the corresponding component.

The master device 21 is configured to inform the reset controller 25 that the master device 21 has requested a reset of the master device 22 or the slave device 23. Specifically, the reset controller 25 comprises a register 251 corresponding to the master device 22 and a register 252 corresponding to the slave device 23. The master device 21 is configured to set the value in the register 251 or the value in the register 252 to a certain value (e.g. 1) so as to inform the reset controller 25 that the master device 21 is requesting a reset of the master device 22 or the slave device 23. In response to the master device 21 requesting a reset of the master device 22 or the slave device 23, the reset controller 25 transmits the reset request signal RST_REQ[0] or the reset request signal RST_REQ[1] which is set to a certain level (e.g. high level). If the bus state monitor 26 determines that the reset is allowed, the bus state monitor 26 transmits the reset acknowledge signal RST_ACK[0] or the reset acknowledge signal RST_ACK[1] which is set to a certain level (e.g. high level). In response to receiving the reset acknowledge signal RST_ACK[0] or RST_ACK[1] which is set to a certain level, the reset controller 25 transmits the reset signal MASTER_RSTn to the master device 22 or transmits the reset signal SLAVE_RSTn to the slave device 23.

Similarly, the master device 22 is configured to inform the reset controller 25 that the master device 22 is requesting a reset of the slave device 23. The master device 22 is configured to set the value in the register 252 to the certain value (e.g. 1) to inform the reset controller 25 that the master device 22 is requesting a reset of the slave device 23. In response to the master device 22 requesting a reset of the slave device 23, the reset controller 25 transmits the reset request signal RST_REQ[1] which is set to the certain level to the bus state monitor 26. If the bus state monitor 26 determines that the reset is allowed, the bus state monitor 26 transmits the reset acknowledge signal RST_ACK[1] which is set to the certain level to the reset controller 25. In response to receiving the reset acknowledge signal RST_ACK[1] which is set to a certain level, the reset controller 25 transmits the reset signal SLAVE_RSTn to the slave device 23.

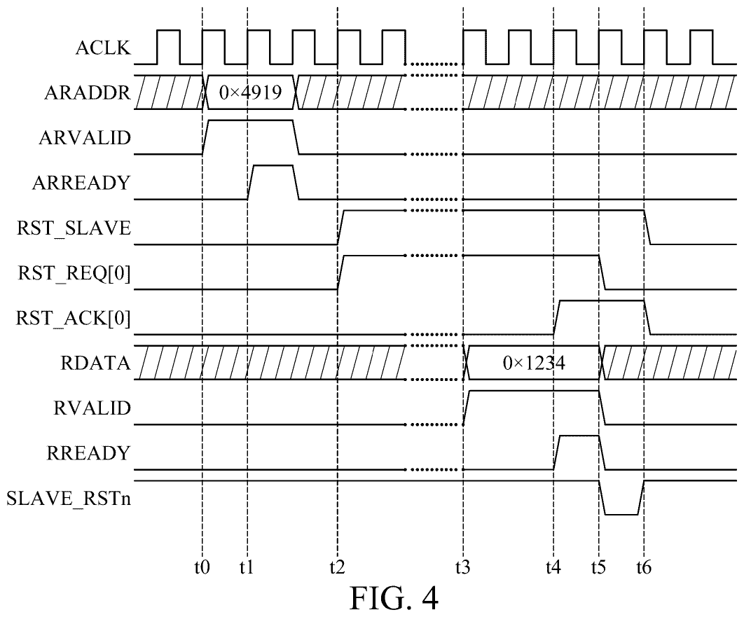

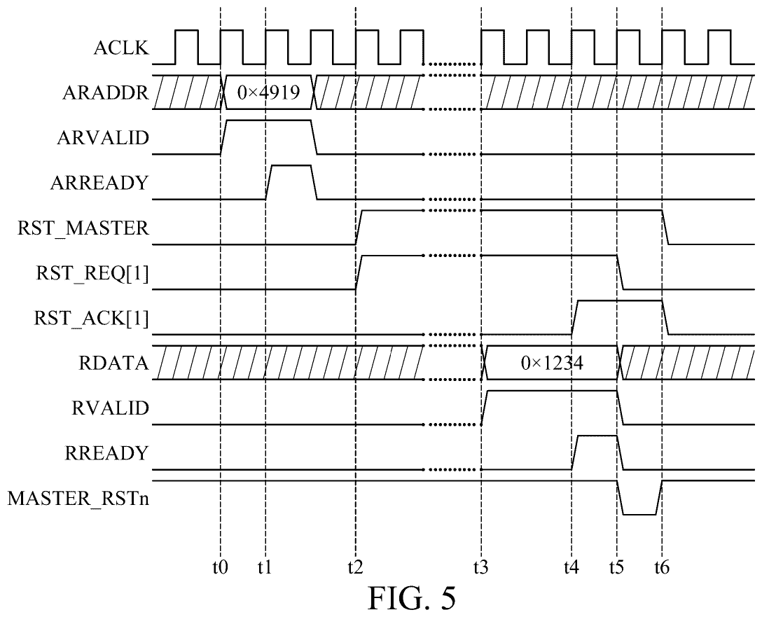

Following describes the operation process of the electronic device 20 referring to FIGS. 4 and 5. Refer to FIG. 4, FIG. 4 is an illustration diagram showing the operation process in accordance with the embodiments of the present disclosure. The operation process shown in FIG. 4 can be implemented in the electronic device 20. FIG. 4 illustrates the embodiment in which the master device 21 is requesting a reset of the slave device 23. The waveform labeled as “RST_SLAVE” illustrates the value in the register 252. At time point t0, the master device 21 requests to read data whose address is 0x4919 in the slave device 23. The master device 21 further set the ARAVALID signal to the high level. At time point t1, the slave device 23 sets the ARREADY signal to the high level to indicate that the slave device 23 has accepted the request from the master device 21 to read data at address 0x4919. At time point t2, the master device 21 set the value in the register 252 to “1” so as to inform the reset controller 25 that the master device 21 is requesting a reset of the slave device 23. Thus, at time point t2, the value of the “RST_SLAVE” is set to 1. In response to the master device 21 requesting a reset of the slave device 23, the reset controller 25 transmits the reset request signal RST_REQ[0] which is set to the high level at time point t2. For example, the reset controller 25 may keep transmitting the high level reset request signal RST_REQ[0] until it receives the high level reset acknowledge signal RST_ACK[0]. Because, at time point t2, the ARREADY signal was once set to the high level, and the RREADY signal hasn't been set to the high level. This means that the slave device 23 has accepted the read request but doesn't transmit the data to the master device 21, and the master device 21 hasn't acknowledged the reception of the data transmitted from the slave device 23. Thus, the bus state monitor 26 determines that the whole transmission procedure isn't complete and prevents the reset signal SLAVE_RSTn from being transmitted to the slave device 23. Specifically, the bus state monitor 26 doesn't transmit the high level reset acknowledge signal RST_ACK[0] to the reset controller 25.

At time point t3, the slave device 23 transmits high level RVALID signal and transmits the RDATA signal to the master device 21. The RDATA signal indicates the data at 0x4919. At time point t4, the master device 21 receives data indicated by the RDATA signal and thus transmits high level RREADY signal to indicate that the master device 21 has received the data. At the same time (at time point t4), the bus state monitor 26 transmits the high level reset acknowledge signal RST_ACK[0] to the reset controller 25, after detecting that the RREADY signal is set to the high level. At time point t5, in response to receiving the reset acknowledge signal RST_ACK[0] which is set to the high level, the reset controller 25 transmits the reset signal SLAVE_RSTn to the slave device 23. Furthermore, at time point t5, the reset controller 25 stops to transmit the high level reset request signal RST_REQ[0]. At time point t6, the reset controller 25 and the bus state monitor 26 stops to transmit the reset acknowledge signal RST_ACK[0] and the reset signal SLAVE_RSTn at the same time. Furthermore, the master device 21 sets the value in the register 252 to 0. Alternatively, the value in the register 252 is automatically erased to become 0. This allows other device to determine whether the reset is completed via reading the value in the register 252.

In the embodiment shown in FIG. 4, the bus state monitor 26 is configured not to transmit the reset acknowledge signal RST_ACK[0] to the reset controller 25 to prevent the reset signal SLAVE_RSTn to be transmitted to the slave device 23, after the slave device 23 has accepted the read request from the master device 21 and before the master device 21 acknowledges the reception of the data transmitted from the slave device 23. The bus state monitor 26 is further configured to transmit the reset acknowledge signal RST_ACK[0] to the reset controller 25 so as to allow the reset signal SLAVE_RSTn to be transmitted to the slave device 23, after the master device 21 has acknowledged the reception of the data transmitted from the slave device 23. In some embodiments, the bus state monitor 26 doesn't transmit the reset acknowledge signal RST_ACK[0] to the reset controller 25, after the slave device 23 transmits the ARREADY signal (e.g. the slave device 23 sets the ARREADY signal on the bus 24 to the high level) and before the master device 21 transmits the RREADY signal (e.g. the master device 21 sets the RREADY signal on the bus 24 to the high level). Furthermore, the bus state monitor 26 transmits the reset acknowledge signal RST_ACK[0], after the master device 21 transmits the RREADY signal (e.g. the master device 21 sets the RREADY signal on the bus 24 to the high level).

Refer to FIG. 5, FIG. 5 is an illustration diagram showing the operation process in accordance with the embodiments of the present disclosure. The operation process shown in FIG. 5 can be implemented in the electronic device 20. FIG. 5 illustrates the embodiment in which the master device 21 is requesting a reset of the master device 22. At time point t0, the master device 22 requests to read data whose address is 0x4919 in the slave device 23. The master device 22 further set the ARAVALID signal to the high level. At time point t1, the slave device 23 sets the ARREADY signal to the high level to indicate that the slave device 23 has accepted the request from the master device 22 to read data at address 0x4919. At time point t2, the master device 21 set the value in the register 251 to “1” so as to inform the reset controller 25 that the master device 21 is requesting a reset of the master device 22. Thus, at time point t2, the value of the “RST_MASTER” is set to 1. In response to the master device 21 requesting a reset of the master device 22, the reset controller 25 transmits the reset request signal RST_REQ[1] which is set to the high level at time point t2. For example, the reset controller 25 may keep transmitting the high level reset request signal RST_REQ[1] until it receives the high level reset acknowledge signal RST_ACK[1]. Because, at time point t2, the ARREADY signal was once set to the high level, and the RREADY signal hasn't been set to the high level. This means that the slave device 23 has accepted the read request but doesn't transmit the data to the master device 22, and the master device 22 hasn't acknowledged the reception of the data transmitted from the slave device 23. In other words, the master device 22 has requested the slave device 23 to transmit data but hasn't receive the requested data. Thus, the bus state monitor 26 determines that the whole transmission procedure isn't complete and prevents the reset signal MASTER_RSTn from being transmitted to the master device 22. Specifically, the bus state monitor 26 doesn't transmit the high level reset acknowledge signal RST_ACK[1] to the reset controller 25.

At time point t3, the slave device 23 transmits high level RVALID signal and transmits the RDATA signal to the master device 22. The RDATA signal indicates the data at 0x4919. At time point t4, the master device 22 receives data indicated by the RDATA signal and thus transmits high level RREADY signal to indicate that the master device 22 has received the data. At the same time (at time point t4), the bus state monitor 26 transmits the high level reset acknowledge signal RST_ACK[1] to the reset controller 25, after detecting that the RREADY signal is set to the high level. At time point t5, in response to receiving the reset acknowledge signal RST_ACK[1] which is set to the high level, the reset controller 25 transmits the reset signal MASTER_RSTn to the master device 22. Furthermore, at time point t5, the reset controller 25 stops to transmit the high level reset request signal RST_REQ[1]. At time point t6, the reset controller 25 and the bus state monitor 26 stops to transmit the reset acknowledge signal RST_ACK[1] and the reset signal MASTER_RSTn at the same time. Furthermore, the master device 21 sets the value in the register 251 to 0. Alternatively, the value in the register 251 is automatically erased to become 0.

In the embodiment shown in FIG. 5, the bus state monitor 26 is configured not to transmit the reset acknowledge signal RST_ACK[1] to the reset controller 25 to prevent the reset signal MASTER_RSTn to be transmitted to the master device 22, after the slave device 23 has accepted the read request from the master device 22 and before the master device 22 acknowledges the reception of the data transmitted from the slave device 23. The bus state monitor 26 is further configured to transmit the reset acknowledge signal RST_ACK[1] to the reset controller 25 so as to allow the reset signal MASTER_RSTn to be transmitted to the master device 22, after the master device 22 has acknowledged the reception of the data transmitted from the slave device 23. In some embodiments, the bus state monitor 26 doesn't transmit the reset acknowledge signal RST_ACK[1] to the reset controller 25, after the slave device 23 transmits the ARREADY signal (e.g. the slave device 23 sets the ARREADY signal on the bus 24 to the high level) and before the master device 22 transmits the RREADY signal (e.g. the master device 22 sets the RREADY signal on the bus 24 to the high level). Furthermore, the bus state monitor 26 transmits the reset acknowledge signal RST_ACK[1], after the master device 22 transmits the RREADY signal (e.g. the master device 22 sets the RREADY signal on the bus 24 to the high level).

In the embodiments shown in FIGS. 4 and 5, the reset controller 25 keeps transmitting the reset signals SLAVE_RSTn, MASTER_RSTn for a cycle of the clock signal. In other embodiments, the reset signals SLAVE_RSTn, MASTER_RSTn are transmitted for more than one cycle of the clock signal. However, the reset acknowledge signals RST_ACK[0], RST_ACK[1] and the reset signals SLAVE_RSTn, MASTER_RSTn stop being transmitted at the same time. When the reset acknowledge signals RST_ACK[0], RST_ACK[1] are at level “0” and the reset signals SLAVE_RSTn, MASTER_RSTn are at level “1”, the reset controller 25 determines that the reset procedure is complete and sets the value in the register 251 or register 252 to 0. The master device 21 and the master device 22 determine that the master device 22 or the slave device 23 has been reset based on the value in the registers 251, 252.

In the embodiment shown in FIG. 5, if the bus state monitor 26 doesn't prevent the reset signal MASTER_RSTn from being transmitted to the master device 22, the master device 22 will lose the information that it has requested for reading the slave device 23, after the master device 22 is reset. Thus, the master device 22 won't transmit the RREADY signal after the slave device 23 transmits the requested data. This will prevent the completion of the handshake mechanism and cause the system stocked. Furthermore, the master device 22 may request to read data in other position in the slave device 23 (e.g. the data at address 0x2344). However, the slave device 23 has transmitted data at address 0x4919. Although the master device 22 wants to read the data at 0x2344, it receives the data at 0x4919. This causes unexpectable situation and error. Embodiments of the present disclosure solve this problem utilizing the above mentioned mechanism.

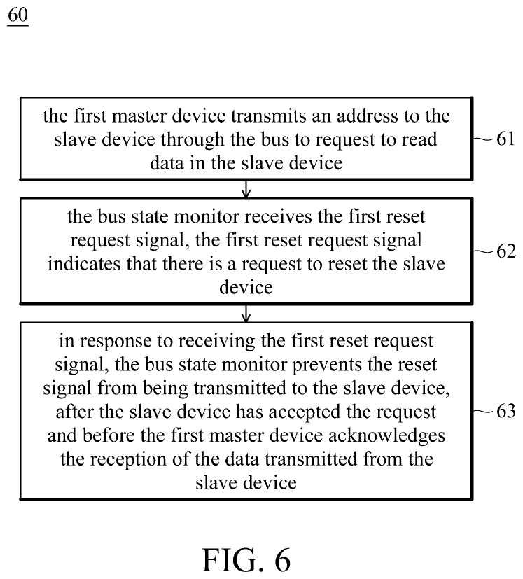

Refer to FIG. 6, FIG. 6 is a flow diagram of the method 60 for managing the reset signal in accordance with the embodiments of the present disclosure. Method 60 is applicable to the electronic devices 10, 20. In operation 61, the first master device (e.g. the master device 11 or 21) transmits an address to the slave device (e.g. the slave device 12, 23) through the bus (e.g. the bus 13 or 24) to request to read data in the slave device. In operation 62, the bus state monitor (e.g. the bus state monitor 14 or 26) receives the first reset request signal (e.g. the first reset request signal REQ_RSRn or RST_REQ[0]). The first reset request signal indicates that there is a request to reset the slave device. In operation 63, in response to receiving the first reset request signal, the bus state monitor prevents the reset signal (e.g. the reset signal SLAVE_RSTn) from being transmitted to the slave device, after the slave device has accepted the request and before the first master device acknowledges the reception of the data transmitted from the slave device. For example, the first master device and the slave device indicate that the slave device has accepted the request or that the first master device has received the data via transmitting signal on the bus. The bus state monitor determines whether to stop the reset signal based on the signals transmitted by the first master device and the slave device on the bus.

In some embodiments, the bus state monitor is configured to allow the reset signal to be transmitted to the slave device, after the first master device acknowledges the reception of the data transmitted from the slave device. In some embodiments, the bus state monitor is configured to prevent the reset signal from being transmitted to the slave device, after the slave device transmits the ARREADY signal and before the first master device transmits the RREADY signal.

In some embodiments, the method 60 further comprises the following operations: the first master device informs the reset controller (e.g. the reset controller 25) that the first master device is requesting a reset of the slave device. In response to the first master device requesting a reset of the slave device, the reset controller transmits the first reset request signal (e.g. the reset request signal RST_REQ[0]) to the bus state monitor. The first reset request signal corresponds to the slave device. The bus state monitor doesn't transmit the first reset acknowledge signal (e.g. the reset acknowledge signal RST_ACK[0]) to the reset controller, after the slave device has accepted the request and before the first master device acknowledges the reception of the data transmitted from the slave device. The first reset acknowledge signal corresponds to the slave device. The bus state monitor transmits the first reset acknowledge signal to the reset controller, after the first master device acknowledges the reception of the data transmitted from the slave device. In response to receiving the first reset acknowledge signal, the reset controller transmits the reset signal (e.g. the reset signal SLAVE_RSTn) to the slave device.

In some embodiments, the method 60 further comprises the following operations: The second master device (e.g. the master device 22) requests to read data in the slave device. The first master device informs the reset controller that the first master device is requesting a reset of the second master device. In response to the first master device requesting a reset of the second master device, the reset controller transmits the second reset request signal (e.g. the reset request signal RST_REQ[1]) to the bus state monitor. The second reset request signal corresponds to the second master device. The bus state monitor doesn't transmit the second reset acknowledge signal (e.g. the reset acknowledge signal RST_ACK[1]) to the reset controller, after the slave device has accepted the request and before the second master device acknowledges the reception of the data transmitted from the slave device. The second reset acknowledge signal corresponds to the second master device. The bus state monitor transmits the second reset acknowledge signal to the reset controller, after the second master device acknowledges the reception of the data transmitted from the slave device. In response to receiving the second reset acknowledge signal, the reset controller is configured to transmit the reset signal (e.g. the reset signal MASTER_RSTn) to the second master device.

In some embodiments, the first master device is configured to set the first register (e.g. register 252) corresponding to the slave device in the reset controller to a certain value (e.g. 1, 0, or other values) so as to inform the reset controller that the first master device is requesting a reset of the slave device. The first master device is configured to set the second register (e.g. register 251) corresponding to the second master device in the reset controller to a certain value (e.g. 1, 0, or other values) so as to inform the reset controller that the first master device is requesting a reset of the second master device.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An electronic device, comprising:
a first master device;
a slave device, connected to the first master device through a bus; and
a bus state monitor, connected to the bus;
wherein:
the first master device is configured to request to read data in the slave device;
the bus state monitor is configured to receive a first reset request signal, wherein the first reset request signal indicates that there is a request to reset the slave device; and
in response to receiving the first reset request signal, the bus state monitor is configured to prevent a reset signal from being transmitted to the slave device, after the slave device has accepted the request and before the first master device acknowledges the reception of the data transmitted from the slave device.

2. The electronic device as claimed in claim 1, wherein the bus state monitor is further configured to allow the reset signal to be transmitted to the slave device, after the first master device acknowledges the reception of the data transmitted from the slave device.

3. The electronic device as claimed in claim 1, wherein the bus state monitor is further configured to:
in response to receiving the first reset request signal, prevent the reset signal from being transmitted to the slave device, after the slave device transmits a ARREADY signal and before the first master device transmits a RREADY signal.

4. The electronic device as claimed in claim 1, further comprising:
a second master device, connected to the slave device through the bus; and
a reset controller, connected to the first master device, the second master device, the slave device, and the bus state monitor;
wherein:
the first master device is configured to inform the reset controller that the first master device is requesting a reset of the slave device;
in response to the first master device requesting the reset of the slave device, the reset controller is configured to transmit the first reset request signal to the bus state monitor, wherein the first reset request signal corresponds to the slave device; and
the bus state monitor doesn't transmit a first reset acknowledge signal corresponding to the slave device to the reset controller, after the slave device has accepted the request and before the first master device acknowledges the reception of the data transmitted from the slave device.

5. The electronic device as claimed in claim 4, wherein:
the bus state monitor is configured to transmit the first reset acknowledge signal to the reset controller, after the first master device acknowledges the reception of the data transmitted from the slave device; and
in response to receiving the first reset acknowledge signal, the reset controller is configured to transmit the reset signal to the slave device.

6. The electronic device as claimed in claim 4, wherein:
the second master device is configured to request to read data in the slave device;
the first master device is further configured to inform the reset controller that the first master device is requesting a reset of the second master device;
in response to the first master device requesting the reset of the second master device, the reset controller is configured to transmit a second reset request signal to the bus state monitor, and the second reset request signal corresponds to the second master device;
the bus state monitor doesn't transmit a second reset acknowledge signal corresponding to the second master device to the reset controller, after the slave device has accepted the request and before the second master device acknowledges the reception of the data transmitted from the slave device;
the bus state monitor is configured to transmit the second reset acknowledge signal to the reset controller, after the second master device acknowledges the reception of the data transmitted from the slave device; and
in response to receiving the second reset acknowledge signal, the reset controller is configured to transmit the reset signal to the second master device.

7. A method for managing reset signals, applied in an electronic device, wherein the electronic device comprises a first master device, a slave device, and a bus state monitor, wherein the slave device connects to the first master device through a bus, and the bus state monitor connects to the bus, wherein the method comprises:
transmitting an address to the slave device through the bus to request to read data in the slave device via the first master device;
receiving a first reset request signal via the bus state monitor, wherein the first reset request signal indicates that there is a request to reset the slave device; and
in response to receiving the first reset request signal, preventing a reset signal from being transmitted to the slave device via the bus state monitor, after the slave device has accepted the request and before the first master device acknowledges the reception of the data transmitted from the slave device.

8. The method as claimed in claim 7, further comprising:
allowing the reset signal to be transmitted to the slave device via the bus state monitor, after the first master device acknowledges the reception of the data transmitted from the slave device.

9. The method as claimed in claim 7, further comprising:
in response to receiving the first reset request signal, preventing the reset signal from being transmitted to the slave device via the bus state monitor, after the slave device transmits a ARREADY signal and before the first master device transmits a RREADY signal.

10. The method as claimed in claim 7, wherein the electronic device further comprises a second master device and a reset controller, the second master device connects to the slave device through the bus, the reset controller connects to the first master device, the second master device, the slave device, and the bus state monitor, wherein the method further comprises:
informing the reset controller that the first master device is requesting a reset of the slave device via the first master device;
in response to the first master device requesting the reset of the slave device, transmitting the first reset signal to the bus state monitor via the reset controller, wherein the first reset request signal corresponds to the slave device;
wherein the bus state monitor doesn't transmit a first reset acknowledge signal corresponding to the slave device to the reset controller, after the slave device has accepted the request and before the first master device acknowledges the reception of the data transmitted from the slave device;
wherein the bus state monitor is configured to transmit the first reset acknowledge signal to the reset controller, after the first master device acknowledges the reception of the data transmitted from the slave device;
wherein, in response to receiving the first reset acknowledge signal, the reset controller is configured to transmit the reset signal to the slave device.
